(19) United States
(12) Patent Application Publication
(10) Pub. No.: US 2008/0123104 A1
(43) Pub. Date: May 29, 2008

(54) HIGH SELECTIVITY BAND-PASS INTERFEROMETER WITH TUNING CAPABILITIES

(75) Inventor: Nicolae Miron, Pierrefonds (CA)

Correspondence Address: DARBY & DARBY P.C., P.O. BOX 770, Church Street Station, New York, NY, 10008-0770, US

(73) Assignee: ROCTEST LTEE, Saint-Lambert, QC (CA)

(21) Appl. No.: 11/945,656

(22) Filed: Nov. 27, 2007

Related U.S. Application Data
(60) Provisional application No. 60/861,082, filed on Nov. 27, 2006.

(51) Int. Cl. G01B 9/02

(52) U.S. Cl. 356/519

(57) ABSTRACT

A tunable optical band-pass device for spectrally filtering an input light beam is provided. The device includes an interferometer having two inner reflective planar surfaces that face each other and are tilted at an angle α with respect to each other, and a translation device for adjusting a relative spacing of the two reflective surfaces, thus tuning the device to any arbitrary wavelength within a broad tuning range. The device also includes an input port for inputting the input light beam in the interferometer and having the input light beam impinge on one of the reflective surfaces at an incidence angle θ with respect thereto which is substantially larger than the tilt angle α, and be partially reflected and partially transmitted by this surface thereby producing multiple transmitted light beams. An optical element for collecting the multiple transmitted light beams and producing a spectrally-filtered output light beam is also included.

### FIELD OF THE INVENTION

The present invention relates to the field of optical components and more particularly concerns a tunable optical band-pass device for spectrally-filtering an input light beam.

### BACKGROUND OF THE INVENTION

Band-pass interferometers have applications in a variety of fields such as tunable lasers and band pass filtering of optical signals. An emerging direction in monitoring equipment for geotechnical and structural engineering is fiber optic sensing. Among the multitude of technologies in use for structure monitoring, fiber optic sensing based on fiber Bragg gratings (FBGs) and Brillouin and Rayleigh scattering has clear advantages such as: immunity to electromagnetic radiation coming mainly from lightening, distributed sensing, easy deployment across large areas, lack of periodic calibration and maintenance-free operation. The interrogators used in fiber sensing technologies for geotechnical and structural engineering instrumentation are based on tunable lasers and also on the selection of optical signals with arbitrary wavelengths within a broad wavelength range.

FBGs have already a wide acceptance in structural monitoring as a string of localized sensors positioned along a single optical fiber at predefined locations. The well-defined wavelength reflected by each individual FBG written in the fiber core contains local information on strain and temperature. The interrogators of FBG-based sensing systems require either tunable lasers within the broadest possible tuning range, or at least band-pass optical filters tunable within the broadest tuning range.

Brillouin scattering and Rayleigh scattering are also very good candidates for structural monitoring using optical fibers. Both of these approaches have the advantage of using just the bare single mode optical fiber such as SMF-28 as a sensor along its entire length. Any arbitrary length along the optical fiber can scatter light under the influence of an external force and temperature change. The strain and temperature information is contained within the wavelength shift of the scattered light. Moreover, interrogating approaches for Brillouin or Rayleigh scattered light, such as optical Fourier domain reflectometry (OFDR) or optical time domain reflectometry (OTDR) can also provide the information on the position along the fiber where either the strain or the temperature have changed. OFDR and OTDR require tunable lasers with well-controlled wavelength.

In optical communications, the decrease of inventory stock is one of the main ways of increasing the profitability of optical networks. One way of decreasing the inventory stock is to replace the large amount of spare modules of fixed-wavelength lasers with a small amount of modules of tunable lasers. Tunable lasers provide easy re-configurability of optical networks. Quality monitoring of optical signals in optical networks is an important aspect in the operation of optical networks. Tunable optical filters are also key elements in optical performance monitoring. Therefore, there is a broad range of applications for good tunable optical filters.

The main parameter to evaluate a band pass filter is the rejection ratio: higher rejection provides a better signal selection. For currently accepted optical filtering technologies, a rejection ratio within the 20 dB to 25 dB range is considered a good number for a single-stage filtering unit. However, in order to satisfy price-performance trade-off, many applications which require a higher rejection ratio use these suboptimal filtering units.

With band-pass interferometers of the type disclosed in U.S. Pat. No. 7,002,696 B1, the theoretical maximum limit of the rejection ratio (RR) is approximately 26 dB, which is insufficient for certain applications, while the band pass at 3 dB (BW) is about 0.01 of the free spectral range (FSR), which is quite large for some applications. It is well known by those skilled in the art that by using state-of-the-art dielectric vacuum deposition technologies, the typical insertion loss within the reflective coatings 203 and 204 of the band-pass interferometer disclosed in U.S. Pat. No. 7,002,696 B1 could be below 0.3 dB. However, in order to keep the overall loss of the filter from the input fiber 216 to the output fiber 217 below 1 dB, the parameters of both fiber optic collimators 215 and 213 must be matched in order to minimize the coupling loss between them and limit the remaining loss budget to about 0.7 dB.

There is therefore a need for improvements to prior art band-pass interferometers.

### SUMMARY OF THE INVENTION

In accordance with the invention, there is provided a tunable optical band-pass device for spectrally filtering an input light beam. The device includes
an interferometer which includes: a first optical element having a first inner surface, the first inner surface being planar and reflective; a second optical element having a second inner surface, the second inner surface being planar and partially reflective, wherein the first inner surface is tilted by a tilt angle α with respect to the second inner surface; and a translation device attached to at least one of the first optical element and the second optical element for adjusting a relative spacing of the first inner surface and the second inner surface;
an input port for inputting the input light beam in the interferometer and having the input light beam impinge on the second inner surface at an incidence angle θ with respect thereto, and be partially reflected and partially transmitted by the second inner surface thereby producing multiple transmitted light beams, and wherein the tilt angle α is substantially smaller than the incidence angle θ; and
an optical collector for gathering the multiple transmitted light beams and producing a spectrally-filtered output light beam.

Preferably, the first inner surface has a reflection coefficient r₁ and the second inner surface has a reflective coefficient r₂ smaller than r₁.

The tunable optical band-pass device may have a vacuum or an optical medium located between the first inner surface and the second inner surface.

Preferably, the tilt angle α is in the range between 0.015 and 0.025 degrees.

Preferably, the incidence angle θ is in the range between 4 and 9 degrees.

The tunable optical band-pass device may also include an input collimator for collimating the input light beam.

The tunable optical band-pass device may further include an output collimator for gathering the multiple transmitted light beams.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIGS. 1A and 1B (PRIOR ART) are schematic diagrams of a band pass interferometer according to two embodiments disclosed in U.S. Pat. No. 7,002,696 B1.

FIG. 2A, FIG. 2B and FIG. 2C (PRIOR ART) are each plot diagrams of transmission versus wavelength characteristic for an interferometer of the type disclosed in FIG. 1A or 1B, for three different gap sizes d.

FIG. 3 is a plot diagram of theoretical transmission versus wavelength, whereby the transmission is determined according to a simplified expression of the transmission function.

FIG. 4 is a schematic diagram of a tunable optical band-pass device according to an embodiment of the present invention.

FIG. 5 is a plot diagram of the theoretical transmission versus wavelength for the tunable optical band-pass device shown in FIG. 4, for a gap size d=94.750 μm.

FIG. 6 is a schematic diagram of a tunable optical band-pass device according to an embodiment of the present invention, showing the tuning of a single peak between the wavelength λ, and the wavelength λ₂.

FIG. 7A is a three dimensional plot of the intensity of the output beam 214 of FIG. 6, showing the peak at position x₁, when the filter is tuned on the wavelength λ₁.

FIG. 7B is a three dimensional plot of the intensity of the output beam 217 of FIG. 6, showing the peak at position x₂, when the filter is tuned on the wavelength λ₂.

FIG. 8 is a plot diagram of a measured transmission function for the tunable optical band-pass device shown in FIG. 4.

FIG. 9 is a schematic diagram of a tunable optical band-pass device according to another embodiment of the present invention.

FIGS. 10 to 15 are schematic diagrams of tunable optical band-pass devices according to various embodiments of the present invention.

### DESCRIPTION OF PREFERRED EMBODIMENTS OF THE INVENTION

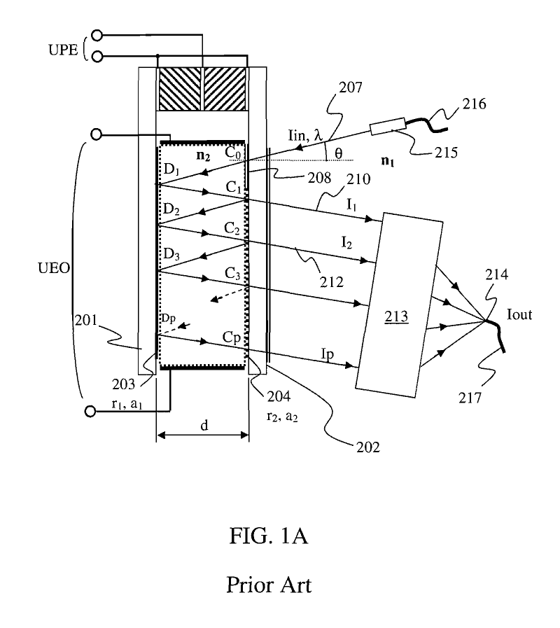

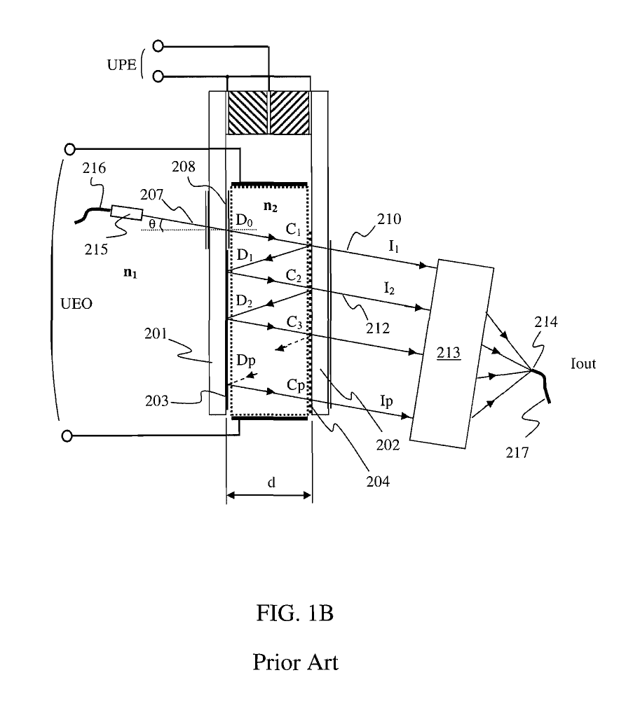

The present invention will be described more fully hereinafter with reference to the accompanying drawings, FIGS. 1 to 15, wherein like numerals refer to like features throughout.

### General Description—Tunable Optical Band-Pass Device

The present invention relates to a tunable optical band-pass device that is used to spectrally filter an input light beam and serves as a high resolution wavelength selection unit. The term “tunable” herein is understood to refer to the ability to adjust and select, i.e. “tune”, spectral features such as the operating wavelength and band-pass. The term “optical” refers to any appropriate portion of the electromagnetic spectrum, e.g. the broad range of electromagnetic spectrum from infrared to ultraviolet, and is not limited to the visible spectrum only.

Various examples of the tunable optical band-pass device according to preferred embodiments of the present invention are illustrated in the accompanying drawings.

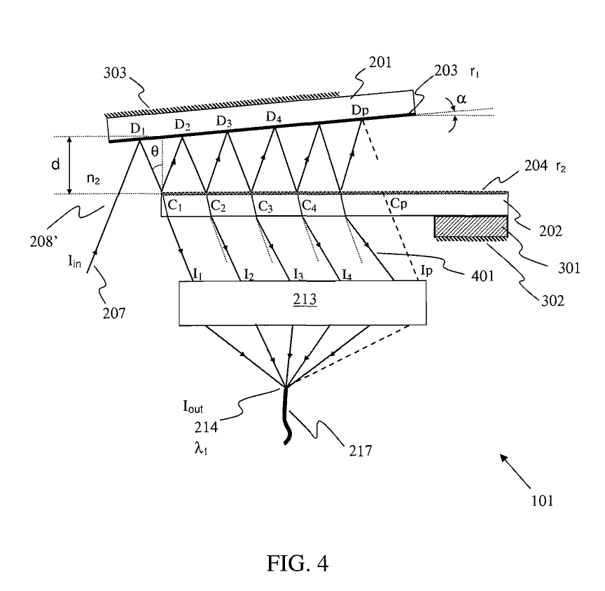

As seen in FIGS. 4, 6 and 9 to 15, each tunable optical band-pass device 101 generally includes an interferometer, an input port for inputting the light beam into the interferometer, and an optical collector for gathering the light beams transmitted by the interferometer and producing a spectrally-filtered output light beam.

The interferometer includes two reflective optical elements: a first optical element 201 having a first inner surface 203 that is planar and reflective, and a second optical element 202 having a second inner surface 204 that is planar and partially reflective. The first inner surface 203 has a reflection coefficient r₁ and said second inner surface 204 has a reflective coefficient r₂ smaller than r₁. The reflective surfaces have low reflection losses. The first inner surface 203 is preferably totally reflective, (i.e. very little intensity of the light beam incident thereon is transmitted through the reflective surface) while the second inner surface 204 is partially reflective, (i.e., a significant portion of the incident thereon light beam, more specifically its intensity, is transmitted through the partially reflective surface). The first and second optical elements 201 and 202 may for example be embodied by mirrored plates, e.g. glass plates provided with appropriate reflective thin film coatings defining the first and second inner surfaces. The first inner surface 203 is tilted by a tilt angle α with respect to the second inner surface 204, as seen in FIGS. 4, and 9 to 15. Preferably, the tilt angle α is in the range from 0.015 to 0.025 degrees, or more preferably 0.02 degrees.

The interferometer further includes a translation device 301 attached to at least one of the mirrored plates 201 and 202 for adjusting the relative position of the mirrored plates, specifically the relative spacing of the first inner surface 203 and the second inner surface 204. The translation device 301 changes the spacing between the reflective surfaces while maintaining the tilt angle α between them. A nanotranslation stage that allows adjustment of the relative spacing of the first inner surface and the second inner surface with angular accuracy better than 1 milliradian is preferable. The translation device 301 may be embodied by a flexure structure driven by a piezoelectric element whereby the adjustment of the relative position of the reflective surfaces is controlled by the piezoelectric control voltage, or by a micro-electromechanical system (MEMS) controlled by a MEMS control voltage, or by any other appropriate means.

A vacuum or an optical medium may be located between the first inner surface 203 and the second inner surface 204. The optical medium may be any medium of appropriate index of refraction n₂ that does not hinder the adjustment of the relative position of the mirrored plates, e.g. air, rare gas, sol-gel, etc.

An optical fiber may be used to guide the input light beam to an input port of the tunable optical band-pass device. Prior to entering the tunable optical band-pass device, the input light beam is preferably collimated using an input collimator 215.

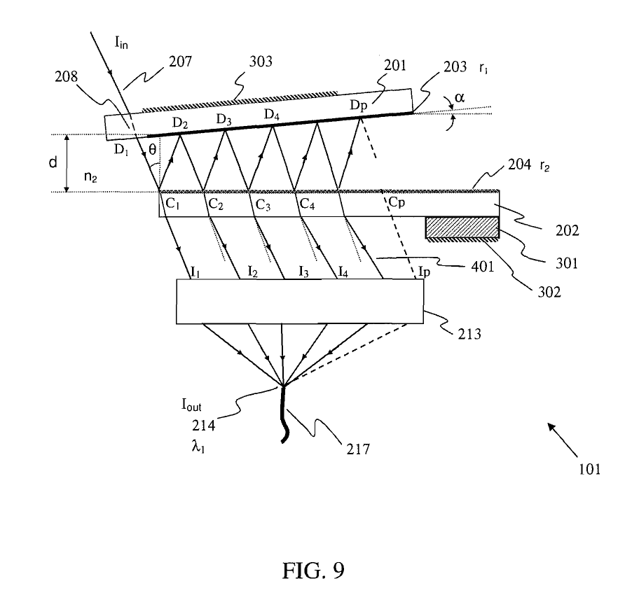

The input collimator 215 may be a fiber optic collimator. The input light beam 207 enters the tunable optical band-pass device via the input port. The input port is such that it allows the input light beam 207 to enter the interferometer and to impinge on the second inner surface 204 of the interferometer at an incidence angle θ, of preferably approximately 8 degrees, with respect thereto, wherein the tilt angle α between the second and first inner surfaces is substantially smaller than the incidence angle θ. The input port may be a light transparent region of the interferometer through which the input light beam 207 may be transmitted to the second inner surface 204. For example, as shown in FIGS. 9, 11, 13, and 15, the input port is simply a light transparent portion of the first optical element 201—region 208 in the mirrored plate 201 acts as an input port allowing the incident input beam 207 to pass through the plate 201 not covered with the reflective surface 203 with very little loss of intensity.

Alternatively, as shown in FIGS. 4, 6, 10, 12, and 14, the input port 208′ may be simply an opening in the interferometer through which the input light beam 207 passes, impinges on the first reflective inner surface 203 and is reflected back to the second reflective inner surface 202. When the input light beam impinges on the second reflective inner surface 202, it is partially transmitted out of the interferometer (see transmitted beam I1) and partially reflected back to the first mirrored plate 201 (see reflected beam C₁D₂) of the interferometer to undergo further reflection and transmission (see reflected beams CₘDₘ₊₁ and transmitted beams I₂, I₃, I₄, . . . ) and thereby produce multiple transmitted light beams (I₂, I₃, I₄, . . . ).

The transmitted light beams are collected and focused into a single spot 214 by an optical collector. The optical collector may include: a spherical lens system, an aspherical lens system, or a gradient-index (GRIN) lens system, or any combination thereof. It may also include a collimator. At the recombination point 214, which is the entrance aperture into the output optical port, the transmitted beams generated by the interferometer undergo interference and produce the spectrally-Filtered output light beam. The output optical port may be simply an optical fiber 217 for guiding the spectrally-filtered output beam out of the device. The tunable optical band-pass device may further include an output collimator for collimating the spectrally-filtered output beam. The optical collector and the output collimator may be combined into one output collimator module 213.

The wavelength-dependent transmission function, which is the ratio between the intensity available at the output port versus the intensity available at the input port, strongly depends on the phase shift introduced between the multiple transmitted beams by the beam-splitting produced with the two mirror plates 201 and 202 of the interferometer, which performs the optical filtering function. By having the first reflective inner surface 203 tilted with respect to the second reflective inner surfaces 204 as in the case of the present invention, this unexpectedly provides a much stronger rejection ratio and narrower bandwidth as compared to the prior art case where the two inner reflective surfaces are parallel. In the present case, the tilt angle between the inner reflective surfaces also provides a means for fine adjustment of either the convergence or the divergence of the input beam, thus optimizing the beam collection efficiency of the optical collector and reducing further the overall insertion loss of the filter. It should be noted that these improved properties are observed when the tilt angle α between the first and second inner surfaces, 203 and 204, is substantially smaller than the incidence angle θ.

### Detailed Description—Tuning Principle

In principle, an optical band-pass device passes a certain range of wavelengths, i.e. a certain bandwidth, while rejecting or attenuating wavelengths outside that range. A tunable optical band-pass device allows to variably select (within certain boundary limitations) the pass band, i.e. the band of wavelengths to be passed. With the tunable optical band-pass device of the present invention, a narrow pass band is selected by adjusting the tilt angle α between the reflective optical elements of the interferometer. The wavelength is selected by using the translation device (e.g. by adjusting the piezoelectric control voltage or the MEMS control voltage to change the spacing between the first and second inner surfaces of the mirrored plates). The transmission maximum is shifted into a broad wavelength range while maintaining very good and constant insertion loss or transmission efficiency for the selected wavelength as well as a constant bandwidth within the entire working range.

The basic tuning principle behind tunable optical band-pass devices is given below with reference to the prior art device described in U.S. Pat. No. 7,002,696 B1. The novel features and advantages of the device of the present invention over the device of the prior art are also made evident below.

Referring to FIGS. 1A and 1B (PRIOR ART), band pass interferometers with tuning capabilities as described in U.S. Pat. No. 7,002,696 B1 consist mainly of two reflective coatings 203 and 204 facing each other and parallel with a tuning gap d between them. The coating 203 has high reflectivity r₁, and the coating 204 has low reflectivity r₂. In the optical configuration shown in FIG. 1A, the incident beam 207 is incident first on the high reflectivity coating 203. In the optical configuration shown in FIG. 1B, the incident beam 207 is incident first on the low reflectivity coating 204. Both optical configurations have the same operating principle. In one embodiment, used more frequently, the gap d is filled with air. Preferably, either the glass plate 201 or the glass plate 202 can be attached firmly to a piezoelectric actuator (not shown neither in FIG. 1A nor in FIG. 1B), used to change the gap size d by monitoring the voltage applied on the piezoelectric device. The other mirror of the interferometer must be locked into a fixed position.

The operation of the configuration shown in FIG. 1A will now be described further. The operation of the configuration shown in FIG. 1B is similar to the operation of the configuration shown in FIG. 1A and so, although the description below is given in relation to FIG. 1A, the operation of the configuration shown in FIG. 1B will be readily apparent therefrom to those knowledgeable in the art. The input beam 207 incident first on the layer 203 at the incidence angle θ is subject to multiple reflections between the layers 203 and 204, within the gap d. At each incidence point on the low reflectivity coating 204, part of the incident beam from inside the gap is transmitted outside of the gap (see transmitted beam 210). In this way, a multitude of transmitted beams are generated. All of the transmitted beams are collected by the output collimator module 213 and are focused into a very narrow region 214 at the entrance aperture of the optical fiber 217. The transmitted beams (210, 212, . . . ) interfere and produce a single beam within the region 214. Throughout the present description, the region 214 will be referred to also as the output beam. Interference maxima of the output beam 214 correspond to the maximum transmission from the input beam 207 to the output beam 214. Interference minima correspond to a minimum transmission from the input beam 207 to the output beam 214. For a broad spectrum of the input beam 207 and for a certain value of the gap d, the output beam 214 has multiple maxima and minima.

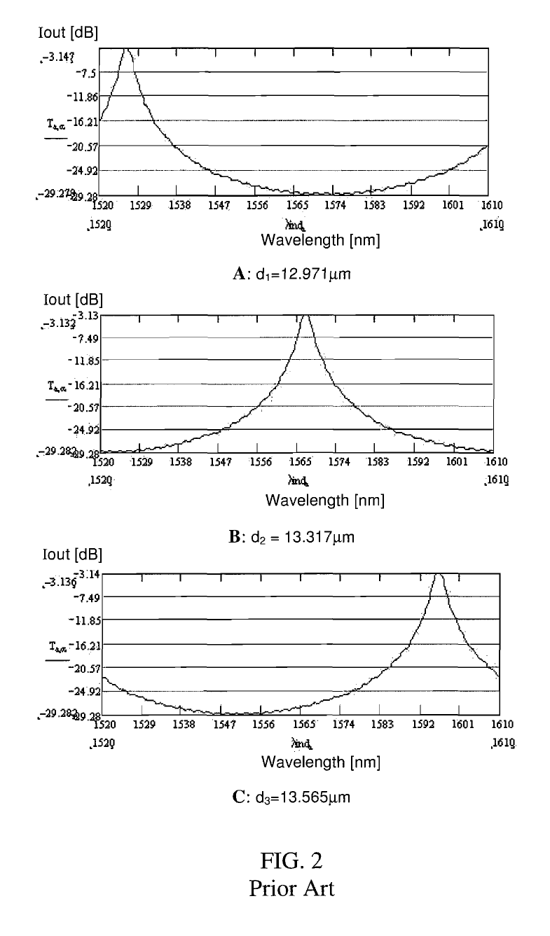

The central wavelength of each maximum and minimum depends on the gap size d and on the incidence angle θ. When increasing d, the entire pattern of peaks shifts towards longer wavelengths. When decreasing d, the entire pattern of peaks shifts towards shorter wavelengths. Only one peak of the entire pattern of peaks is shown in FIGS. 2A, 2B and 2C (PRIOR ART), for clarity purposes. The spacing between two adjacent peaks will be referred to as the free spectral range (FSR), in keeping with Fabry-Perot interferometers and terminology commonly used in the art. The bandwidth of each maximum depends on its central wavelength, the FSR, the reflectivity of both layers 203 and 204 and the number p of transmitted outgoing beams (210, 212, . . . ). Within each FSR, the filter has band pass transmission properties. FIGS. 2A, 2B and 2C show some details of the transmission function within the spectral range between 1520 nm and 1610 nm for three different gap sizes: d₁=12.971 μm, d₂=13.317 μm and d₃=13.565 μm. The operating spectral range of the filter depends on the spectral properties of the reflective coatings 203 and 204 and of the gap size. For the filter embodiments according to the prior art and for the gap size d=13 μm, the rejection ratio is about 26 dB, and the 3-dB bandwidth is about 1.7 nm or 0.01 of FSR, as it is shown in FIGS. 2A, 2B and 2C.

The band pass filter with tuning capabilities disclosed in the prior art has some limitations related to the transmission function, such as:

(i) a maximum theoretical limit of the rejection ratio (RR) of 26 dB which is insufficient for certain applications; and
(ii) a band pass (BW) at 3 dB of about 0.01 FSR, which is quite large for some applications.

Several applications, such as tunable lasers built with tunable optical filters and some interrogators for Brillouin scattering and Rayleigh scattering in fiber sensing systems require rejection ratios better than 25 dB. A narrower band pass on the order of 0.1 nm at 3-dB would also be preferable for these applications.

As previously mentioned, the prior art has some limitations regarding the geometry of the rays traveling from the input collimator 215 to the output collimator 213, as shown in FIG. 1A and FIG. 1B. In the interferometer of the prior art, the reflective coatings 203 and 204 are parallel. A collimated circular light beam 207 at the input will give at the output a multitude of overlapping and parallel collimated beams (210, 212, . . . ) having an elliptical cross-section envelope, with the large axis contained in the plane of the transmitted beams. The collimating lens of the output collimator module 213 along with the optical fiber 214 serve as an output fiber optic collimator for collecting the entire elliptical output beam or most of it and directing it to the entrance aperture of the optical fiber with circular shape. It is obvious that there will always be some losses that will contribute to the overall loss of the filter. The overall loss of the filter is given by the loss within the coatings 203 and 204 and by the transmission loss between the input collimator 215 and the output collimator module 213. It is well known by those skilled in the art that by using state-of-the-art dielectric vacuum deposition technology, the typical insertion loss within the reflective coatings 203 and 204 of the embodiment of the prior art could be below 0.3 dB. In order to keep the overall losses of the filter from the input fiber 216 to the output fiber 217 below 1 dB, it is a design challenge for the prior art to match the parameters of both fiber optic collimators 215 and 213 in order to minimize the coupling loss between them within the remaining loss budget of about 0.7 dB.

In reality, the input beam 207 is slightly convergent near the exit aperture of the collimator 215. Accordingly, the multiple transmitted beams (210, 212, . . . ) could be either slightly divergent or slightly convergent, depending on the working distance of the fiber collimator 215. The gap d is in the order of 100 μm; therefore, after the multiple reflections within the gap there will be no significant difference in the position of the individual waists of the output beams (210, 212, . . . ); each of them and also their ensemble could be considered either convergent, or divergent. It would be advantageous to be able to change the convergence (divergence) of each beam (210, 212, . . . ) and of their ensemble, too, which would help the design of both input and output collimators for minimizing the overall insertion loss of the filter.

It is known by those skilled in the art that the transmission function of a filter is an equation expressing the output intensity as a function of wavelength, assuming a constant intensity at the input regardless the wavelength (uniform power spectrum density). Prior art teaches a detailed equation of the transmission function of the optical configurations shown in FIG. 1A and FIG. 1B, where the reflective coatings of the filter are parallel. In order to simplify the explanations but to also keep the accuracy of the physical aspects, only the main elements of FIGS. 1A and 1B will be presented hereinafter, such as:
(1) the reflectivities r₁ and r₂ of the reflective coatings
(2) the incidence angle θ≈8°;
(3) the tilt angle α;
(4) the intensity Iᵢₙ of the input beam;
(5) the intensity of the output beam Iₒᵤₜ; and
(6) the number p of the beams with significant intensity (>1% of the intensity of the first emerging beam I₁) emerging through the low reflectivity coating.

Therefore, by using the computational methodology described in M. Born, E. Wolf, “Principles of Optics” Chapter 7.6, pp. 359-409, 7-th Edition, Cambridge University Press, Cambridge, 1999, some simplified equations are given below for the transmission function of the embodiments of the prior art shown in FIG. 1A and FIG. 1B.

The Elementary Optical Phase Difference (EOPD), defined as the phase shift introduced by the optical path difference between two adjacent emerging beams (such as C₁D₂C₂ and subsequent paths in FIG. 1A, C₁D₁C₂ and subsequent paths in FIG. 1B) is denoted as φ(λ):

$$φ ( λ , d ) = \frac{4 \cdot π \cdot {n}_{2}}{λ \cdot cos θ} \cdot d \qquad ( 1 )$$

where d is the tuning gap, and λ is the wavelength.

It is a very well established procedure for those skilled in the art (see the reference by Born et al cited above) to compute the transmission function ITPₒᵤₜ(λ,d) of the filter according to the embodiment of the prior art:

$${ITP}_{out} ( λ , d ) = 10 \cdot log [ \frac{{r}_{1} \cdot ( 1 - {r}_{2} )}{{I}_{i n}} \cdot \frac{{A}^{2} ( λ , d ) + {B}^{2} ( λ , d )}{{ϛ}^{2} ( λ , d )} ] \qquad ( 2 )$$

where the input intensity Iᵢₙ=constant across the operating wavelength range of the filter, and A(λ,d), B(λ,d) and ζ(λ,d) are some auxiliary functions:

$$\begin{matrix}A ( λ , d ) = {( {r}_{1} \cdot {r}_{2} )}^{\frac{p + 1}{2}} \cdot cos ( ( p - 1 ) \cdot φ ( λ , d ) ) - {( {r}_{1} \cdot {r}_{2} )}^{\frac{p}{2}} \cdot cos ( p \cdot φ ( λ , d ) ) - {( {r}_{1} \cdot {r}_{2} )}^{\frac{1}{2}} \cdot cos ( φ ( λ , d ) ) & ( 3 ) \\ B ( λ , d ) = {( {r}_{1} \cdot {r}_{2} )}^{\frac{p + 1}{2}} \cdot sin ( ( p - 1 ) \cdot φ ( λ , d ) ) - {( {r}_{1} \cdot {r}_{2} )}^{\frac{p}{2}} \cdot sin ( p \cdot φ ( λ , d ) ) + {( {r}_{1} \cdot {r}_{2} )}^{\frac{1}{2}} \cdot sin ( φ ( λ , d ) ) & ( 4 ) \\ ϛ ( λ , d ) = 1 + {r}_{1} \cdot {r}_{2} - 2 \cdot {( {r}_{1} \cdot {r}_{2} )}^{\frac{1}{2}} \cdot cos ( φ ( λ , d ) ) & ( 5 )\end{matrix}$$

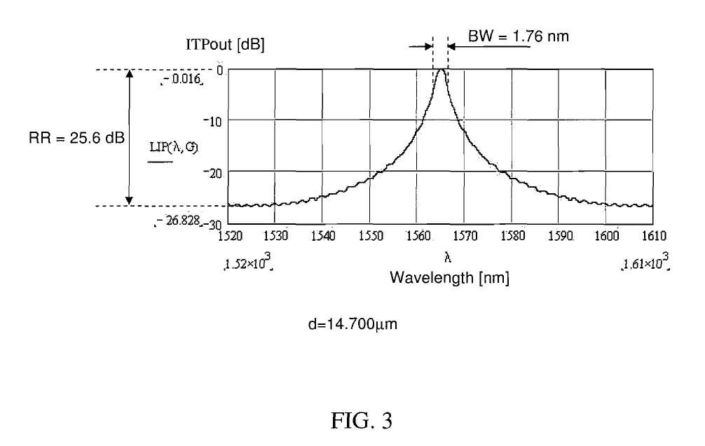

FIG. 3 is an example of the plot diagram of the transmission function according to equation (2) for a gap size d=14.700 μm, which is very similar to the plots disclosed in the prior art (FIGS. 2A, 2B and 2C). Therefore, equation (2) could be considered a good mathematical model of the optical setups of the prior art (FIG. 1A and FIG. 1B). It gives the theoretical achievable limits of the preferred embodiment of the band pass interferometer with tuning capabilities according to the prior art:

| | |
|---|---|
| rejection ratio (RR) = | 26 dB, and |
| bandwidth at 3 dB (BW) = | 0.02 * FSR |

The tunable optical band-pass device of the present invention improves upon the selectivity of the prior art device. Preferably, as shown in FIG. 4, the reflective inner surfaces 203 and 204 are tilted with a small angle α=0.025°, much smaller than the incidence angle θ=8°. The tilt angle α is within the plane of the emergent beams, the reflective layers being closer towards the entrance port of the light beam. The tilt is shown much larger in FIG. 4, for clarity purposes. The tunable optical band-pass device according to the embodiment of the present invention shown in FIG. 4 increases the divergence: the output beams are more divergent than the input beam 207. The transmission function ITTe(λ,d) of the filter (i.e device) as shown in FIG. 4 can be computed using a procedure known to those skilled in the art (see Born et al.). An exact equation of the transmission function is however difficult to compute and to plot. A fairly good approximation of the transmission function ITTe(λ,d) giving results very close to the experimental measurements could be:

$$ITTe ( λ , d ) = 10 \cdot log \{ \frac{{r}_{1} \cdot ( 1 - {r}_{2} )}{{I}_{i n}} \cdot [ \begin{matrix}{( \begin{matrix}1 + \sqrt{{r}_{1} \cdot {r}_{2}} \cdot {A}_{2} ( λ , d ) + \\ \frac{{r}_{1} \cdot {r}_{2}}{{Z}_{m} ( λ , d )} \cdot {A}_{3} ( λ , d )\end{matrix} )}^{2} + \\ {( \begin{matrix}\sqrt{{r}_{1} \cdot {r}_{2}} \cdot {B}_{2} ( λ , d ) + \\ \frac{{r}_{1} \cdot {r}_{2}}{{Z}_{m} ( λ , d )} \cdot {B}_{3} ( λ , d )\end{matrix} )}^{2}\end{matrix} ] \} \qquad ( 6 )$$

where:
r₁, r₂, n₂, Iᵢₙ and p have the same meaning as in the prior art,
b appearing in the equations below is a parameter dependent on the beam geometry, and
the auxiliary functions: K(λ), Γ₁(d), γ(d), M(λ,d), N(λ,d), Q(λ,d), A₂(λ,d), A₃(λ,d), B₂(λ,d) and B₃(λ,d) are given below:

$$K ( λ ) = \frac{4 \cdot π \cdot {n}_{2}}{λ \cdot cos ( θ )}$$

$${Γ}_{1} ( d ) = [ 1 + ( sin ( α ) ) \cdot tan ( θ ) ] \cdot d$$

$$γ ( d ) = 2 \cdot ( tan ( α ) ) \cdot ( tan ( θ ) ) \cdot d$$

$$M ( λ , d ) = K ( λ ) \cdot ( {Γ}_{1} ( d ) + b \cdot γ ( d ) )$$

$$N ( λ , d ) = K ( λ ) \cdot [ ( p - 2 ) \cdot {Γ}_{1} ( d ) + ( 3 + ( p - 2 ) \cdot b ) \cdot γ ( d ) ] \\ Q ( λ , d ) = 3 \cdot K ( λ ) \cdot ( {Γ}_{1} ( d ) + γ ( d ) )$$

$${A}_{2} ( λ , d ) = cos [ K ( λ ) \cdot {Γ}_{1} ( d ) ] + \sqrt{{r}_{1} \cdot {r}_{2}} \cdot cos [ K ( λ ) \cdot ( 2 \cdot {Γ}_{1} ( d ) + γ ( d ) ) ]$$

$${A}_{3} ( λ , d ) = \sqrt{{( {r}_{1} \cdot {r}_{2} )}^{p - 2}} \cdot cos [ N ( λ , d ) - M ( λ , d ) ] - \sqrt{{( {r}_{1} \cdot {r}_{2} )}^{p - 3}} \cdot cos ( N ( λ , d ) ) - \sqrt{{r}_{1} \cdot {r}_{2}} \cdot cos [ M ( λ , d ) - Q ( λ , d ) ] + cos ( Q ( λ , d ) )$$

$${B}_{2} ( λ , d ) = sin ( K ( λ ) \cdot {Γ}_{1} ( d ) ) + \sqrt{{r}_{1} \cdot {r}_{2}} \cdot sin [ K ( λ ) \cdot ( 2 \cdot {Γ}_{1} ( d ) + γ ( d ) ) ]$$

$${B}_{3} ( λ , d ) = \sqrt{{( {r}_{1} \cdot {r}_{2} )}^{p - 2}} \cdot sin [ N ( λ , d ) - M ( λ , d ) ] - \sqrt{{( {r}_{1} \cdot {r}_{2} )}^{p - 3}} \cdot \\ sin ( N ( λ , d ) ) - \sqrt{{r}_{1} \cdot {r}_{2}} \cdot sin [ M ( λ , d ) - Q ( λ , d ) ] + sin ( Q ( λ , d ) )$$

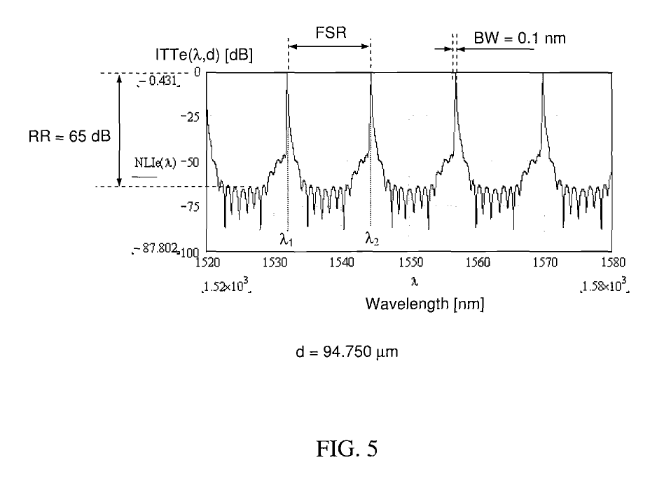

The plot diagram of the transmission function versus wavelength according to the equation (6) for d=94.750 μm gap is shown in FIG. 5. According to this plot, the theoretical rejection ratio is RR=65 dB, and the bandwidth at 3 dB is BW=0.1 nm for a free spectral range FSR=12.7 nm. According to the results shown in the graph of FIG. 5, the band pass interferometer with tilted mirrored plates and tuning capabilities according to the present invention has better theoretical limits:

| | |
|---|---|
| rejection ratio (RR) = | 65 dB, and |
| bandwidth at 3 dB (BW) = | 0.01 * FSR |

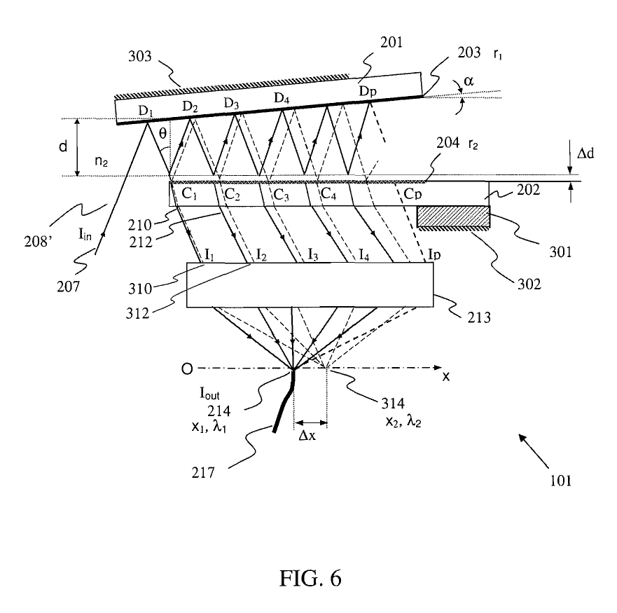

A preferred tuning mechanism for an embodiment of the tunable optical band-pass device of the present invention involves changing the gap size as it is shown in FIG. 6, where the partially reflective inner surface 202 is attached to the translation device 301. The totally reflective inner surface 201 is bonded to an unmovable frame 303. By increasing the gap size from d to (d+Δd), the pattern of peaks shown in FIG. 5 shifts towards longer wavelengths, keeping the quasi-periodicity of FSR. The difference between two adjacent free spectral ranges (FSR) is 0.001 of the peak wavelength; therefore, across about 15 successive FSR, their value could be considered constant. When shifting the entire peak pattern by about 100 nm, each FSR value changes by 0.001 of the peak wavelength. The wavelength tuning mechanism explained herein in connection to FIG. 6 is valid also for the embodiments of the present invention shown schematically in FIGS. 9 to 15.

It is well known to those knowledgeable in the art that the insertion loss or IL is the peak value of the transmission function as expressed by the equations (2) or (6). Herein further it will be assumed that: (1) the reflective coatings 203 and 204 have a constant (flat) reflectivity within their operating spectral range (could be up to 200 nm), (2) the input collimator 207 and the output collimator 213 have no (or negligible) chromatic aberrations within the operating spectral range of the coatings, (3) all the peaks of the transmission function have the same IL (negligible changes) across this spectral range.

In the embodiment of the present invention shown in FIG. 6, by increasing the gap size from d to (d+Δd), the entire peaks pattern shown in FIG. 5 shifts toward longer wavelengths with a certain amount, dependent on the gap size d and on the wavelength range. In particular for a single peak, its wavelength changes from λ₁ to λ₂>λ₁, or the band pass filter tunes from λ₁ to λ₂. If the gap size decreases from d to (d−Δd), the peaks pattern shifts with the same amount in the opposite direction. Into a preferred embodiment of the invention shown in FIG. 6, one side of the piezoelectric actuator 301 has firmly attached to it the glass plate 202 with partial reflecting coating. The other side of the piezoelectric actuator 301 is bonded to a rigid base 302. The plate 201 with totally reflecting coating 203 is bonded to an unmovable base 303. Those knowledgeable in the art know how to monitor the displacement of the plate 202 with very high accuracy by using the piezoelectric actuator 301; therefore, the preferred embodiment of this invention can tune a single transmission peak of the pattern such as in FIG. 5, with very high accuracy to any arbitrary wavelength within a broad tuning range by controlling the voltage applied to the piezoelectric actuator 301. In the preferred embodiment of this invention shown in FIG. 6, the change of the gap size from d to (d+Δd) will also produce a shift in the position of the output beams (I₁, I₂, I₃ . . . ) shown by the dashed lines in FIG. 6. The shift in the position of (I₁, I₂, I₃ . . . ) beams further produces a change Δx in the position of the output beam 214. This change Δx could be so substantial, that the beam 214 could move out of the entrance aperture of the optical fiber 217. It is also possible that the lateral shift of all (I₁, I₂, I₃ . . . ) beams could push the beams totally out of the entrance aperture of the fiber optic collimator assembly made by the output collimator module 213 and the optical fiber 217. Either the shift Δx of the beam 214 or the shift of the entire pattern of (I₁, I₂, I₃ . . . ) beams will further increase the rejection ratio of the filter.

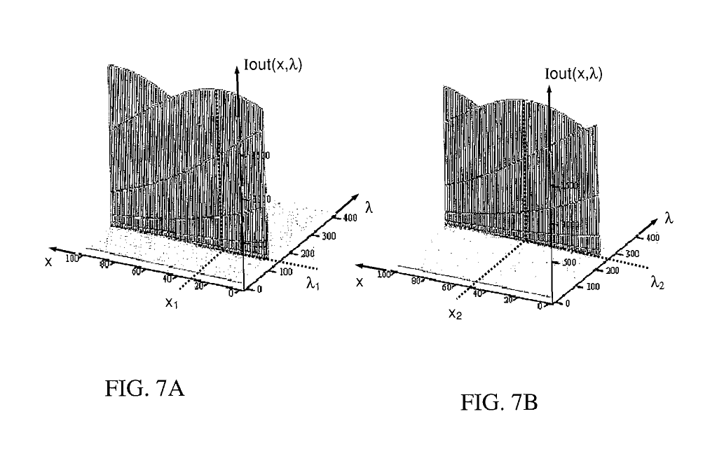

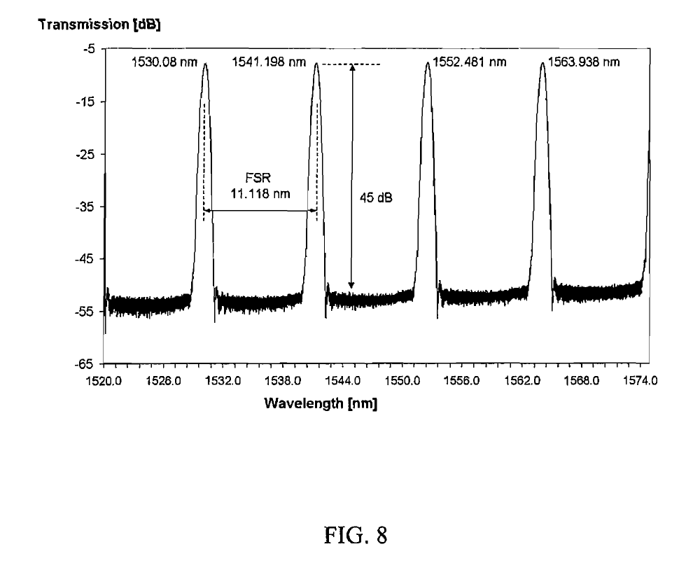

FIG. 7A and FIG. 7B are three-dimensional plots of the equation (6), showing the spatial shift along Ox axis of the peak intensity of the output beam 214 within the focal region of the output fiber optic collimator 213. The shifts in the position of the output beams explained hereinabove produce a very strong rejection of the band pass filter. Experimental measurements of the transmission function shown in FIG. 8 give 45 dB typical rejection ratio and 3-dB bandwidth of 0.02·FSR, which are much better values than the theoretical limits of the prior art. The differences between the theoretical plot shown in FIG. 5 and the measurement shown in FIG. 8 come from multiple sources, such as: (1) the approximations used in computations, (2) departures from the optimum alignment of the optical elements, (3) optical noise, (4) electrical noise associated with the measuring instrumentation and (5) the internal algorithms used by the measuring instrumentation to generate the measurement results.

Advantageously, the tunable optical band-pass device of the present invention has a lower insertion loss than prior art interferometers.

For those knowledgeable in the art, the insertion loss flatness is the constant insertion loss regardless of the peak wavelength as shown in FIGS. 2A, 2B, 2C, 5 and 8. The flat insertion loss throughout the entire tuning range leads to an important tuning feature for optical devices of the type described herein: tuning to any arbitrary wavelength is achieved by adjusting any peak of the transmission function of FIG. 5 to the required wavelength within a single FSR only. The FSR size can be adjusted within a broad range such as from 3 nm to 100 nm by adjusting the gap size d, without sacrificing the advantages such as low insertion loss and insertion loss flatness. Therefore, tuning to any arbitrary wavelength within a specified wavelength range can be achieved by proper adjustment of the gap size via the control voltage on the piezoelectric actuator 301.

As it was mentioned herein above, the reflective coatings of the optical configurations of the prior art shown in FIG. 1A, FIG. 1B, have typically below 0.3 dB insertion loss. The dominant component of the overall insertion loss of the filter from the input collimator 215 (shown only in FIG. 1A and FIG. 1B) to the output collimator module 213 comes from the mismatch between these two collimators, mainly due to the beam expansion inherent to the operating principle of the band pass interferometer with tuning capabilities according to the previous art: the incoming narrow beam is converted into a multitude of overlapping transmitted beams. The cross section of the output beam envelope is an ellipse with its long axis perpendicular on the optical axis of the output beams (210, 212, . . . ). The tilt angle α between the reflective inner surfaces 203 and 204 provides a better rejection ratio and also a narrower bandwidth, as it was explained herein above.

The adjustment of the tilt angle α can make the output beams (210, 212, . . . ) either convergent, or collimated or divergent, producing a change in the divergence of the input beam 207.

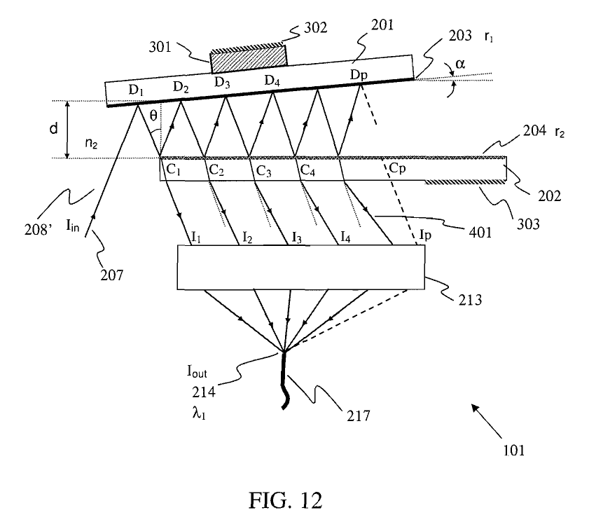

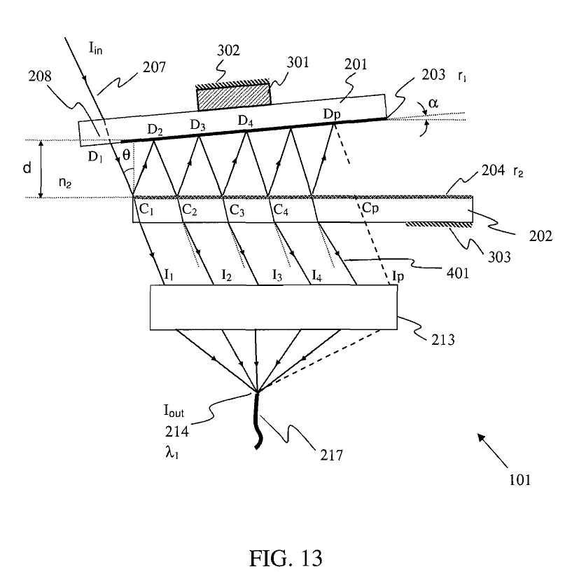

The embodiments of the present invention shown in FIGS. 4, 9, 12 and 13 have the reflective coatings 203 and 204 tilted towards the side where the input beam 207 enters into the tuning gap—the gap is smaller at the entrance side of the beam. The only difference between the embodiments of FIGS. 4 and 12 and FIGS. 9 and 13 is in the entrance geometry of the input beam 207—the embodiments shown in FIG. 9 and FIG. 13 have one reflection less than the embodiment shown in FIG. 4 and FIG. 12. Accordingly, in the embodiments shown in FIG. 9 and FIG. 13, the partially reflective coating 204 is between the input beam 207 and the output beam 214. In all FIGS. 4, 9, 12 and 13, the dotted lines show the direction 401 of the transmitted beams (210, 212, . . . ) assuming a parallel position of the reflective coatings 203 and 204, according to the embodiments of the prior art.

When the reflective coatings 203 and 204 are tilted as in the preferred embodiments of this invention shown in FIGS. 4, 9, 12 and 13, the transmitted beams (210, 212, . . . ) will be more divergent than the input beam 207. If the beam 207 is convergent, the transmitted beams (210, 212, . . . ) can be either less convergent than the beam 207, or collimated, or divergent. If the beam 207 is either collimated or divergent, the transmitted beams (210, 212, . . . ) will be only divergent.

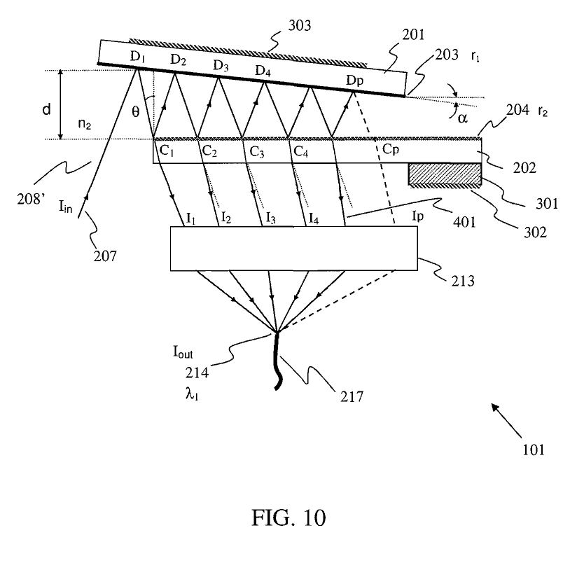

FIG. 10 shows schematically another embodiment of the present invention, having the reflective coatings tilted with an angle α towards the side opposed to the entrance of the beam. The gap is decreasing with the number of reflections—the gap becomes smaller when the number of reflections is increasing. The dotted lines show the direction 401 of the transmitted beams (210, 212, . . . ) assuming the parallel position of the reflective coatings 203 and 204, according to the embodiments of the prior art. The embodiment shown in FIG. 10 reduces the divergence of the input beam 207. If the beam 207 is divergent, the transmitted beams (210, 212, . . . ) can be either less divergent, or collimated, or convergent. If the beam 207 is either collimated or convergent, the transmitted beams (210, 212, . . . ) will be only convergent.

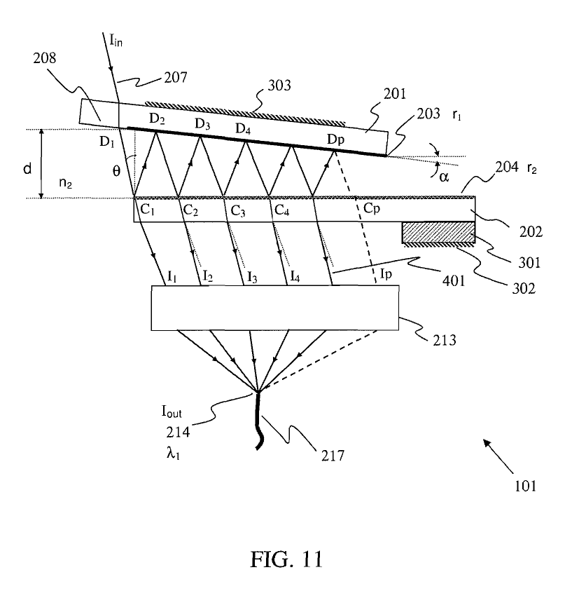

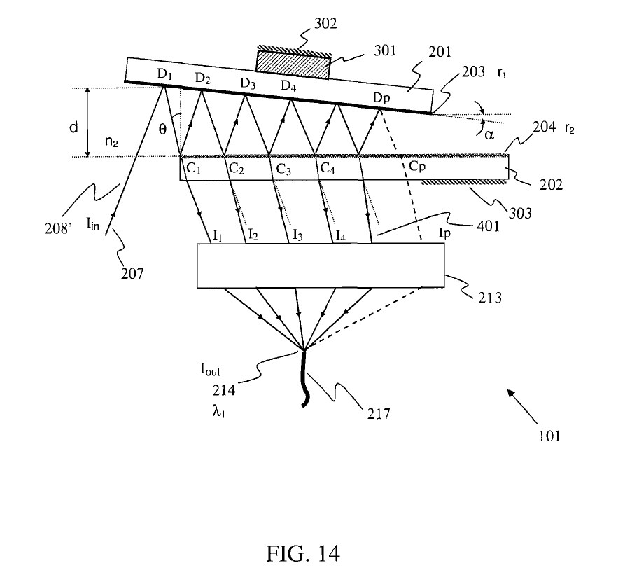

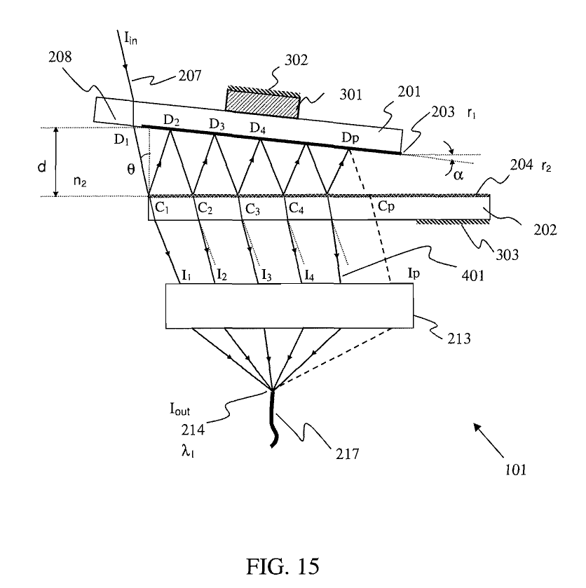

The embodiments of the present invention shown schematically in FIG. 11 and FIG. 15 have the same operation as the embodiments of the present invention shown in FIG. 10 and FIG. 14. In the embodiments shown in FIG. 11 and FIG. 15, the partially reflective inner surface 204 is between the input beam 207 and the output beam 214, which is the only difference between the embodiments of the present invention shown in FIG. 10 and FIG. 14, and those shown in FIG. 11 and FIG. 15.

In summary, the tunable optical band-pass device of the present invention provides a higher rejection ratio (e.g. 40 db or 50 db instead of the typical 25 db), greater selectivity (e.g. up to 100-fold improvement), and lower overall insertion losses than prior art devices.

Of course, numerous modifications could be made to the embodiments described above without departing from the scope of the present invention.

1. A tunable optical band-pass device for spectrally filtering an input light beam, said device comprising:
an interferometer, comprising:
a first optical element having a first inner surface, said first inner surface being planar and reflective;
a second optical element having a second inner surface, said second inner surface being planar and partially reflective, wherein said first inner surface is tilted by a tilt angle α with respect to said second inner surface; and
a translation device attached to at least one of said first optical element and said second optical element for adjusting a relative spacing of said first inner surface and said second inner surface;
an input port for inputting the input light beam in said interferometer and having the input light beam impinge on the second inner surface at an incidence angle θ with respect thereto, and be partially reflected and partially transmitted by said second inner surface, thereby producing multiple transmitted light beams, and wherein said tilt angle α is substantially smaller than said incidence angle θ; and
an optical collector for gathering said multiple transmitted light beams and producing a spectrally-filtered output light beam.

2. A tunable optical band-pass device according to claim 1, wherein said first inner surface has a reflection coefficient r₁ and said second inner surface has a reflective coefficient r₂ smaller than r₁.

3. A tunable optical band-pass device according to claim 1, wherein said first optical element and said second optical element are glass plates provided with reflective coatings defining said first and second inner surfaces.

4. A tunable optical band-pass device according to claim 1, comprising a vacuum or an optical medium located between said first inner surface and said second inner surface.

5. A tunable optical band-pass device according to claim 4, wherein said optical medium comprises air or rare gas.

6. A tunable optical band-pass device according to claim 1, wherein the translation device comprises a nanotranslation stage for adjusting said relative position of said first inner surface and said second inner surface.

7. A tunable optical band-pass device according to claim 1, wherein said translation device comprises a piezoelectric element.

8. A tunable optical band-pass device according to claim 1, wherein said translation device comprises a micro-electromechanical system (MEMS).

9. A tunable optical band-pass device according to claim 1, wherein said tilt angle α is in the range between 0.015 and 0.025 degrees.

10. A tunable optical band-pass device according to claim 9, wherein said tilt angle is 0.02 degrees.

11. A tunable optical band-pass device according to claim 1, further comprising an input collimator for collimating the input light beam.

12. A tunable optical band-pass device according to claim 1, wherein said incidence angle θ is in the range between 4 and 9 degrees.

13. A tunable optical band-pass device according to claim 12, wherein said incidence angle θ is 8 degrees.

14. A tunable optical band-pass device according to claim 1, wherein said optical input port is a light transparent region of the interferometer through which the input light beam is transmissively inputted.

15. A tunable optical band-pass device according to claim 14, wherein said light transparent region is a light transparent portion of the first optical element.

16. A tunable optical band-pass device according to claim 1, wherein said optical input port includes an optical fiber.

17. A tunable optical band-pass device according to claim 1, wherein said optical collector comprises a spherical lens system, an aspherical lens system, or a gradient-index (GRIN) lens system, or any combination thereof.

18. A tunable optical band-pass device according to claim 17, wherein said optical collector comprises a collimator.

19. A tunable optical band-pass device according to claim 1, comprising an optical fiber for guiding said spectrally-filtered output light beam.

20. A tunable optical band-pass device according to claim 1, comprising an output collimator for collimating the multiple transmitted light beams.
